(19) United States
(12) Patent Application Publication
(10) Pub. No.: US 2024/0022151 A1
(43) Pub. Date: Jan. 18, 2024

(54) INSTALLATION ASSEMBLY AND METHOD FOR PRODUCING AN INSTALLATION ASSEMBLY

(71) Applicant: Robert Bosch GmbH, Stuttgart (DE)

(72) Inventor: Vincent Fix, Herrlisheim (FR)

(21) Appl. No.: 18/256,251

(22) PCT Filed: Dec. 2, 2021
(86) PCT No.: PCT/EP2021/083979

§ 371 Date: Jun. 7, 2023

(30) Foreign Application Priority Data
Dec. 17, 2020 (DE) 10 2020 216 119.4

(51) Int. Cl. H02K 24/00; H02K 1/276; H02K 11/21

(52) U.S. Cl. CPC H02K 24/00; H02K 1/276; H02K 11/21

(57) ABSTRACT

The invention relates to an installation assembly (10) for an electric machine (motor or generator) and to a method for producing such an installation assembly (10).

Installation assemblies (10) comprising a rotor shaft (16), a rotor (12) anchored on the rotor shaft (16) in a rotationally fixed manner, and a rotor device (20) which rotates together with the rotor (12) are known for example from electronically actuatable machines (motors or generators).

The invention relates to an advantageous design of the rotor device (20).

According to the invention, means (28a, 28b; 28c) are arranged on the rotor device (20) for fixing the rotor device (20) on the rotor (12) in a part comprising the rotor device (20), wherein the means (28a; 28b; 28c) protrude from the rotor device (20) in the direction of the longitudinal axis L of the rotor shaft (16) and can be introduced into paired recesses (28a; 28b; 28c) of the rotor (12).

An installation assembly (10) is provided which is inexpensively constructed, has few individual parts, and is easily and durably secured on the rotor (12).

### BACKGROUND

The invention relates to an installation assembly as well as to a method for producing such an installation assembly.

Installation assemblies are preferably used in electrically controllable machines, e.g., in electric motors for driving work machines or in generators for power generation. The installation assembly comprises a rotor shaft, a rotor arranged in a rotationally fixed manner on the rotor shaft, as well as a device that rotates together with the rotor (hereinafter referred to as a rotor device). For example, such a rotor device can be a fan gear, a pump element, or a pulse transmitter gear for sensing a rotor position and/or rotor movement. This list is not exhaustive and is not to be construed as limiting.

One preferred application for such an installation assembly is a motor for driving pressure means conveyors in electronically slip-controllable braking systems of motor vehicles.

Using the pressure means conveyed by these pressure means conveyors, brake pressure is built up in wheel brakes of these braking systems, the level of which is proportional to the volume of the pressure means conveyed.

For computational detection or evaluation of the displaced volume of pressure means and/or for an optimization of an electronic drive of the motor, among other things, it is necessary to have knowledge of the rotational movement or the rotational position of the rotor. For this purpose, the installation assembly comprises a pulse transmitter as the rotor device. The pulse transmitter cooperates with a stationary pulse receiver, which generates signals representing the rotational movement and forwards them to an electronic control unit for evaluation.

These signals enable the electronic control unit to electrically control the motor, as well as other electrically controllable actuators of a brake system, such that a brake pressure of the wheel brakes can be controlled as needed and on a radius-specific basis, taking into account the slip ratios prevailing on the paired wheels.

Spinning wheels can thus be prevented. Furthermore, the driving stability of a vehicle can be improved, and/or a braking operation can be performed independently of a present driver's braking request, depending on a momentary traffic situation.

An electrically actuatable aggregate having an installation assembly is disclosed, e.g., in patent application no. DE 10 2018 222 842.

This known aggregate comprises a conventionally constructed rotor with a packet of sheet-metal vanes on which a plurality of magnets are arranged circumferentially adjacent to one another. These magnets cooperate in a known manner with magnets of a stator of this motor such that the rotor and rotor shaft are driven to perform a rotational motion. The stator is housed in a motor housing in which the rotor shaft is rotatably supported.

In said prior art, a pulse transmitter is provided as a rotor device that is arranged centrally on the rotor and rotates with the rotor. The pulse transmitter is designed as an annular disc-shaped circuit board, which is provided with a wing-shaped coating consisting of electrically conductive and electrically non-conductive portions for the formation of regions that are detectable by a pulse receiver. This circuit board is mechanically attached on the rotor, e.g., by rivets or alternative connecting means.

The pulse transmitter and the pulse receiver cooperate with one another according to an inductive measuring principle. For this purpose, the pulse receiver comprises an excitation coil and a detector coil, which, upon rotation of the pulse transmitter, are passed over by the electrically conductive regions in alternation with the electrically non-conductive regions of the signal generator. In this case, a variable voltage is induced in the detector coil, from which the rotational movement of the signal generator as well as the position of the rotor in the space can be derived.

The advantage of such a direct arrangement of the pulse transmitter on the rotor is the short structure of the installation assembly or an aggregate equipped therewith in the direction of a longitudinal axis of the rotor shaft. In addition, a relatively precise detection of the angle of rotation of this rotor is possible, because almost no inertial-based torsion of the rotor shaft occurs between the pulse transmitter and the rotor due to the oncoming acceleration or deceleration forces.

Nevertheless, a circuit board with a wing-shaped coating is relatively expensive to manufacture, and additional operations are also necessary in order to secure the circuit board on the rotor. When riveting or bolting is employed as the connecting means, this leads to an increase in the number of components as well as the weight and thus the inertia torque of the assembly. In addition, when installation the circuit board or the rotor device, relatively high specifications regarding the concentricity of this circuit board to a longitudinal axis of the rotor shaft must be met on the rotor in order to not impair the precision of the rotation angle detection. For the same reasons, deformations of the pulse transmitter are undesirable under operating conditions and, of course, the fixation must also be designed robustly such that the pulse transmitter does not detach from the rotor during operation.

### SUMMARY

By contrast, an installation assembly according to the features of the disclosure has the advantage that the rotor device can be more cost-efficiently produced than in the prior art described. Said assembly can be implemented in a few working steps in terms of deformation technology and can be permanently fixed on the rotor in a simple manner. During the manufacture of the rotor device, the necessary fixation means can be formed integrally with the rotor device and implemented as a plurality provided on the rotor device. In addition, the fixation means can be positioned on the rotor device corresponding to their assigned function and optimized in a constructive manner. Separate fixation elements, e.g., screws, rivets, or the like are omitted, so the installation assembly is made up of fewer total individual parts. The process for a permanent fixation of a rotor device on the rotor is simplified by means of the invention, thus accordingly reducing assembly costs. Using a rotor device attached on the rotor, the installation assembly build is quite compact in the direction of at least the longitudinal axis of the rotor shaft.

In one advantageous embodiment of the invention, at least the means for a rotationally fixed and an axially fixed fixation of the rotor device on the rotor are designed to be separate from one another. They are respectively designed as flat tongues with a rectangular tongue cross-section. The flat tongues protrude from the rotor device at least approximately perpendicularly in the direction of the rotor and can thereby be simply inserted into recesses on the rotor, which are designed for this purpose.

Given the differing lengths of the respective means in the direction of the longitudinal axis of the rotor shaft, it can be achieved that the means come into successive engagement with the rotor during the assembly of the rotor device, i.e., one after the other. A centering of the rotor device on the rotor is in this case performed first, followed by a rotationally fixed fixation, and finally an axially fixed fixation. As a result, an extremely robust fixation of the rotor device on the rotor is achieved.

For an effective, rotationally fixed fixation of the rotor device on the rotor, flat tongues have proven particularly advantageous, the latter being provided with a longitudinal slit and adjoining the wall of the paired recesses under a tangential bias (when viewed in the circumferential direction of the rotor shaft).

In contrast, for axial fixation of the rotor device, the flat tongues continue in a spring portion, which is intended to be applied to a front face of the rotor under the influence of an axial force aimed in the direction of the longitudinal axis of the rotor shaft, before an interlocking connection is established with a shoulder of a recess, into which the flat tongue extends by means of a deformation of the flat tongue. After unloading the spring portion, the component elasticity of the spring arm portion effects a clearance within the interlocking connection established between the flat tongue and the shoulder in the direction of the front face of the rotor, which the rotor device adjoins. The elasticity force thus supports the adjoining position of the rotor device on the rotor. In addition, the level of this elasticity force is adjustable by the design of the spring portion in an application-specific manner.

The spring portion and flat tongue form an angle with one another of less than 90°. It is thus achieved that the flat tongue protrudes at least approximately perpendicularly from the rotor device in the non-axially loaded state of the spring portion and, after this spring arm portion is exposed to the axial force, is inclined obliquely in a preferred direction. In this context, said preferred direction specifies the direction in which the tongue wraps when its free end is exposed to a force countering the axial force by means of a plunger.

An advantageous sequence of the steps for fixing the rotor device on the rotor is also described.

Further advantages or advantageous embodiments of the invention follow from the claims and/or from the description hereinafter.

### BRIEF DESCRIPTION OF THE DRAWINGS

An exemplary embodiment of the invention is illustrated in the drawings and explained in greater detail in the subsequent description.

The drawings consist of a total of 7 figures for this purpose, in which:

FIG. 1 shows the installation assembly three-dimensionally in an oblique position from the front,

FIG. 2 shows the rotor device or the pulse transmitter gear of the installation assembly as a single part, three-dimensionally and obliquely from below, and

FIGS. 3a, 3b, 3c, and 3d show the process for axial fixation of the rotor device or the pulse transmitter gear on the rotor using various installation steps, whereby the installation assembly is shown in these figures respectively in longitudinal section, and

FIG. 4 shows a detailed perspective of the installation assembly at the beginning of the production process.

Each of the respective components bears uniform reference characters in the drawings.

### DETAILED DESCRIPTION

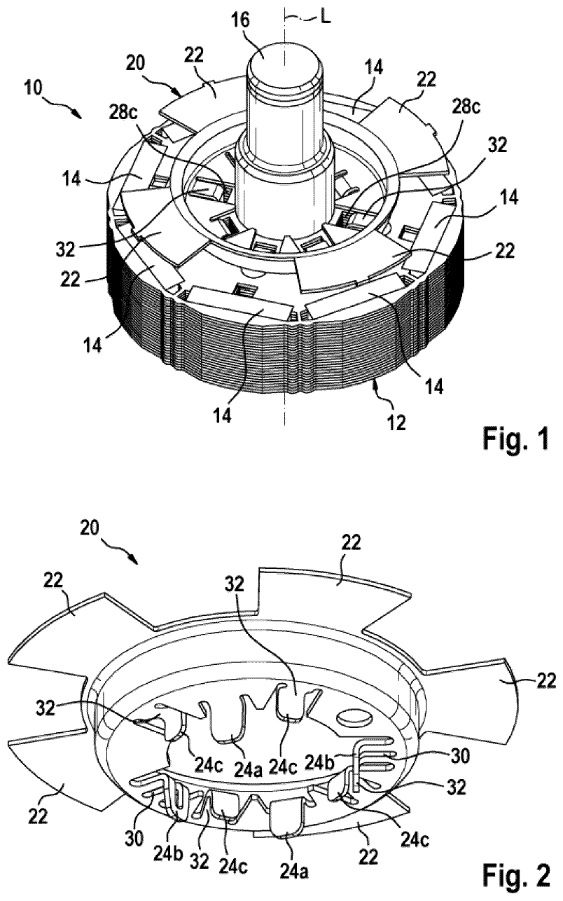

FIG. 1 illustrates the installation assembly (10) underlying the invention. This installation assembly (10) comprises a conventionally constructed rotor (12) with a stack of stacked metal vanes on which a plurality of circumferentially adjacent magnets (14) are provided. These magnets (14) cooperate in a known manner with magnets of a stator (not shown) such that the rotor (12) and a rotor shaft (16), on which this rotor is fixed (12), are driven to perform a rotational movement.

The installation assembly (10) shown in FIG. 1 further comprises a rotor device (20), which is arranged on the rotor shaft (16) centrally in relation to the rotor (12) and rotates together with the rotor (12). By way of example, this rotor device is a pulse transmitter gear (20) of a pulse transmitter for sensing the rotational movement of the rotor (12) or the rotor position.

In the exemplary embodiment, a plurality of wings are formed on the pulse transmitter gear (20), which wings form electrically conductive portions, whereas wingless regions situated between the wings form electrically non-conductive portions. Winged and wingless regions are arranged successively on the pulse transmitter wheel in the direction of rotation in alternation.

The pulse transmitter gear (20) comprises a hub that is, e.g., shaped as a flat plate. A plate edge is aimed away from the rotor (12) and protrudes substantially perpendicularly from a planar plate base. The aforementioned wings (22) extend radially outwards from the edge of the plate.

The plate base is intended to adjoin in a flush manner against a flat front face of the rotor (12). In the adjoining state, there is an axial distance between the wings (22) of the pulse transmitter wheel (20) and the front face of the rotor (12), which distance can be determined by selecting the height of the plate edge.

The rotor (12) and the pulse transmitter gear (20) of the installation assembly (10) rotate with one another and are arranged centrally on the rotor shaft (16). Centering can, e.g., occur via a centering opening arranged in the center of the hub of the pulse transmitter gear (20), the dimensions of which are only slightly larger than an outer diameter of the rotor shaft (16). Alternatively or additionally, means can be designed for centering on the plate base of the pulse transmitter wheel (20).

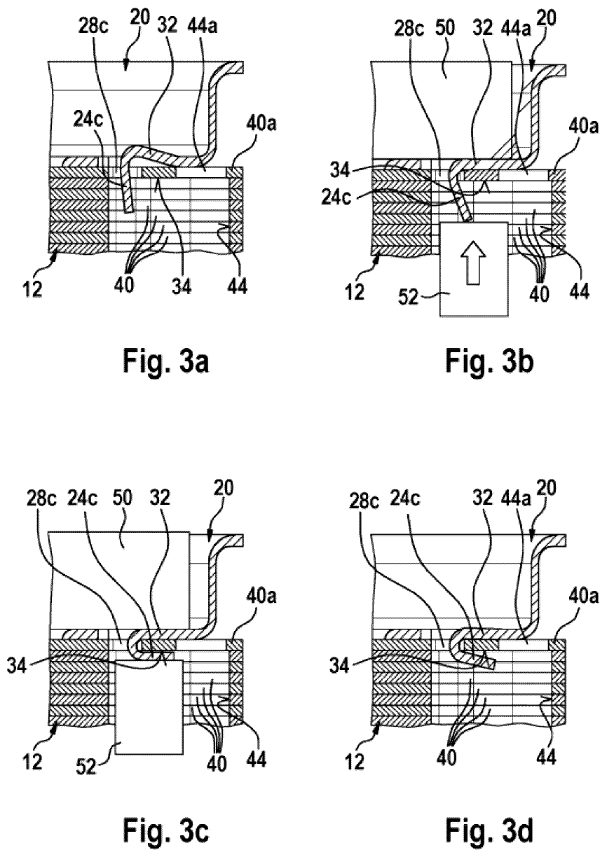

It can otherwise be assumed that the pulse transmitter wheel (20) according to FIG. 1 is fixed on the rotor (12), i.e., fixedly anchored, and that the provided fixation is effective in both the rotational direction of the installation assembly (10) and the axial direction of a longitudinal axis L of the rotor shaft (16). Said axial fixation is discussed in further detail in connection with the description of FIGS. 2 and 3a-d.

In FIG. 2, which shows the pulse transmitter wheel (20) three-dimensionally as a single part from obliquely below, differently designed means (24a; 24b; 24c) for fixing this pulse transmitter wheel (20) on the rotor (12) can be seen in detail. These means (24a; 24b; 24c) are designed the form of flat tongues with a rectangular tongue cross-section. They protrude largely perpendicularly from the base of the plate-shaped hub of the pulse transmitter gear (20) in the direction away from the wings (22) and towards the front face of the rotor (12), where the plate base of the pulse transmitter gear (20) is intended to adjoin in a flush manner.

A plurality of respective means (24a; 24b, 24c) are provided in this exemplary embodiment. By way of example, a total of 8 flat tongues are provided in three different design types. They are arranged at a lateral distance to one another along an inner circumference of the centering opening in the center of the plate base of the pulse transmitter gear (20). Located between the individual means (24a; 24b; 24c) are the remaining portions of the plate base of the hub of the pulse transmitter gear (20).

The protruding means (24a-c) or flat tongues are of different length, e.g., in three lengths. The longest first flat tongues (24a) have a solid cross-section. They are provided together with second flat tongues (24b) for centering the pulse transmitter gear (20) on the rotor (12). These first flat tongues (24a) are diametrically opposed to one another and firstly engage with recesses (28a) formed on the sheet-metal vanes (40) of the rotor (12) during the joining process of the pulse transmitter wheel (20) on this rotor (12). The dimensions of the first flat tongues (24a) are, when viewed in a circumferential direction of the pulse transmitter wheel (20), matched to the corresponding dimensions of the paired first recesses (28a) on the rotor (12) such that a small radial or lateral clearance is established between the first flat tongues (24a) and the wall of the first recesses (28a).

The second flat tongues (24b) are in this case aligned obliquely or transversely to the first flat tongues (24a), have a medium length, and are also provided in duplicate. They are not diametrically opposite to one another, but instead form an angle of 120° with one another. These second flat tongues (24b) have an exemplary longitudinal slit (30) extending along their extension axis, which terminates, e.g., at a distance from the free end of these second flat tongues (24b) and extends to feet of the second flat tongues (24b). This longitudinal slit (30) imparts upon the second flat tongues (24b) a component elasticity that is transverse to their axis of extension. A width of second recesses (28b) paired with these second flat tongues (24b) on the rotor (12) is selected such that the second flat tongues (24b) adjoin the wall of these second recesses (28b) with a radial bias. As a result, these second flat tongues (24b) together with the paired second recesses (28b) are suitable for permanently ensuring a rotationally fixed fixation of the pulse transmitter wheel (20) on the rotor (12). During the course of the joining process of the pulse transmitter gear (20) on the rotor (12), these slitted second flat tongues (24b) engage with the respective paired second recesses (28b) on the rotor (12) at a time after the first flat tongues (24a). Together with the first flat tongues (24a), the second flat tongues (24b) cause the pulse transmitter gear (20) to be centered on the rotor (12).

Finally, third flat tongues (24c), which are still relatively short (and, e.g., four of which are implemented) are provided on the pulse transmitter wheel (20) shown. These are arranged distributed along the periphery of the opening in the plate base of the pulse transmitter gear (20) such that they are located at the corners of an imaginary square. These third flat tongues (24c) continue at their second end opposite the free end in a spring arm portion (32). The latter extends transversely to the third flat tongue (24c) and thus runs radially in the direction of the outer circumference of the plate base. The spring arm portion (32) is in this case inclined obliquely relative to the plate base into the interior of the plate of the hub, so that a transition point from the spring arm portion (32) to the third flat tongue (24c) faces the plate edge or the wings (22) arranged in that location. Each spring arm portion (32) forms an angle that is less than with the respective third flat tongue (24c) paired therewith. The inclination of the spring arm portion (32) is in this case adjusted to said angle such that the third means (24c) at least then protrude substantially perpendicularly from the plate base as long as the paired spring arm portion (32) is unloaded. As a result, third flat tongues (24c) formed at the end of the spring arm portion (32) can also be easily inserted into contemplated third recesses (28c) on the rotor (12). The short third means (24c) are intended for axial fixation of the pulse transmitter gear (20) on the rotor (12) in the direction of the longitudinal axis L of the rotor shaft (16). They do not enter into engagement with the third recesses (28c) provided on the rotor (12) until just before the pulse transmitter wheel (20) adjoins the front face of the rotor (12) in a flush manner. These third flat tongues (24c) are intended to be mechanically deformed after their introduction into the recesses (28c) of the rotor (12) and applied to shoulders (34) formed inside the paired recesses (28c) of the rotor (12). The sequence of this process is described below with reference to FIGS. 3a-d.

In FIGS. 3a-d, the same detail of an installation assembly (10) is shown during different phases for axially fixing the pulse transmitter wheel (20) on the rotor (12). The detailed views illustrate a stack of sheet metal vanes (40) of the rotor (12) in the region of a third recess (28c) formed on the rotor (12), the pulse transmitter gear (20) which has already adjoined the front face of the rotor (12) in a flush manner, e.g., a third flat-tongue or a third means (24c) for axially fixing the pulse transmitter gear (20) on the rotor (12), which engages through said third recess (28c), and the spring arm potion (32) paired with the third flat tongue (24c).

The stack, which can be seen in the lower part of the figures, consists of individual sheet-metal vanes (40) which are designed uniformly with one another and are stacked together in a cooperative manner, with the exception of the first sheet-metal vane (40a), which forms the front face of the rotor (12) and is located at the top in the figures. A continuous opening (44) is provided on each sheet metal vane (40). The openings (44) together form a hole in the rotor (12) that is continuous up to the lowest sheet metal vane and open to the environment.

The topmost sheet metal vane (40a) partially covers the openings (44) of the underlying sheet metal vanes (40). A recess (28c) in the topmost sheet metal vane (40a) opens into the hole of the stack of sheet-metal vanes (40) formed by the openings (44). Given that the dimensions of the recess (28c) in the topmost sheet-metal vane (40a) are smaller than the dimensions of the openings (44) of the remaining sheet metal vanes (40), an edge around this recess (28c) on its side facing the sheet metal vanes (40) forms a shoulder (34) that cooperates with the third flat tongue (24c).

Instead of merely one topmost sheet metal vane (40a) with one recess (28c), it is conceivable to stack a plurality of such sheet metal vanes (40a) with a respective recess (28c) and to use them as the topmost sheet metal vane (40a).

In FIG. 3a, it can be seen that the spring arm portion (32) of the third flat tongue (24c) extends obliquely into the interior of the plate of the hub of the pulse transmitter gear (20) due to its incline to the plate base of the pulse transmitter gear (20). The inclination of the spring arm portion (32) and the angles formed between the spring arm portion (32) and the third flat tongue (24c) are in this case aligned such that the third flat tongue (24c) protrudes substantially perpendicularly from the plate base of the pulse transmitter gear (20). By way of the recess (28c) in the topmost sheet metal vane (40a), this third flat tongue or third means (24c) protrudes into the interior of the hole of the rotor (12) formed by the underlying sheet metal vanes (40).

As shown in FIG. 3b, in a first method step, the spring arm portion (32) is exposed by means of a first plunger (50) to an axial force A acting in the direction of the longitudinal axis L of the rotor shaft (16) in the transition region from the spring arm portion (32) to the flat tongue (24c). The spring arm portion (32) is elastically deformed by this force until it adjoins the front face of the rotor (12) in a flush manner. The angle between the spring arm portion (32) and the flat tongue (24c) does not change in this case, so this flat tongue (24c) then protrudes diagonally into the hole of the rotor (12) formed by the openings (44) of the sheet metal vanes (40).

As shown in FIG. 3c, in a next step, proceeding from the side facing away from the pulse transmitter wheel (20), a second plunger (52) is then inserted into the hole of the rotor (12). The second plunger (52) exposes the oblique third flat tongue (24c) inside this hole to a force counter to the axial force of the first plunger (50). Given the oblique position, the third flat tongue (24c) in this case turns in the preferred direction until its free end finally engages the shoulder (34) formed on the topmost sheet metal vane (40a) or the topmost vane stack. The pulse transmitter gear (20) is as a result fixed on the rotor (12) in the axial direction of the longitudinal axis L of the rotor shaft (16) in an interlocking manner.

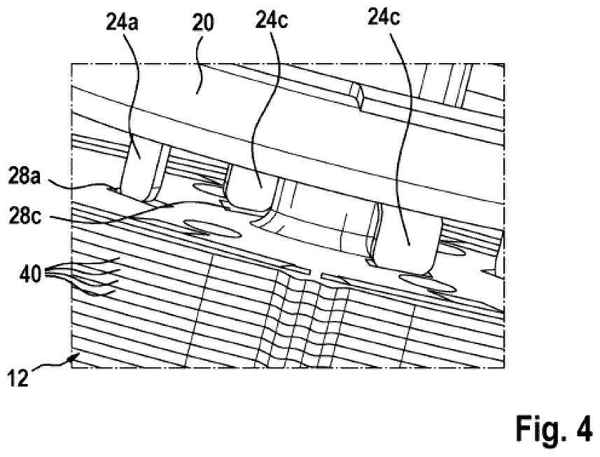

FIG. 3d shows the installation assembly (10) in the finished state. Both plungers (50, 52) are thereby retracted so that, given the then effective component elasticity of the spring arm portion (32), the third flat tongue (24c) adjoins the shoulder (34) of the topmost sheet metal vane (40a) of the vane packet (40), so the pulse transmitter gear (20) presses against the front face of the rotor with an axial bias. Given the component elasticity of the spring arm portion (32), the adjoining position of the pulse transmitter wheel (20) on the rotor (12) is thus ensured permanently and reliably, even under changing operating conditions.

Whereas FIGS. 3a-3d disclose the various operations for axially fixedly securing the pulse transmitter wheel (20) on the rotor (12), and thus the final steps in producing the installation assembly, FIG. 4 shows a detail of the installation assembly (10) at the beginning of its production process. The rotor shaft (16) with the rotor (12) constructed from the sheet-metal vanes (40) and arranged on the rotor shaft, as well as the pulse transmitter wheel (20) intended to be fixed on the rotor (12), are easily recognizable. In the state depicted, the pulse transmitter gear (20) is not yet adjoining the front face of the rotor (12), as a result of which the first and third spring tongues (24a; 24c) are visible in the gap between the pulse transmitter gear (20) and the topmost sheet-metal vane (40a) of the rotor (12) for fixing the pulse transmitter gear (20) on the rotor (12). The spring tongues protrude from the pulse transmitter gear (20) at least approximately axially parallel on the rotor shaft (16) in the direction of the rotor (12). However, the detail view underlying FIG. 4 does not show any slitted spring tongues or second means (24b) for fixing the pulse transmitter wheel (20) in the direction of rotation on the rotor (12).

The spring tongues (24a; 24c) shown each have a solid tongue cross-section. When viewed in the direction of the longitudinal axis L of the rotor shaft (16), the spring tongues (24a; 24c) shown have different extension lengths. In the illustration, the axially longer spring tongues (24a) are already engaging with paired recesses (28a) on the rotor (12), whereas the third spring tongues (24c) are still outside their paired recesses (28c) and are only engaging during the further course of the assembly method, when the pulse transmitter wheel (20) is brought closer on the rotor (12) than shown.

The contour of the recesses (28a; 28c) on the rotor (12) corresponds at least to a large extent to the cross-sectional shape of the paired flat tongues (24a; 24c) and is accordingly likewise rectangular.

Of course, amendments or further developments of the exemplary embodiment described are conceivable without deviating from the basic concept of the invention.

In this context, it should again be noted that the rotor device explained is only described by way of example in reference to the pulse transmitter wheel (20). This pulse transmitter gear (20) need not, as described, be designed in the shape of a pot, but can alternatively also have a disc shape or any other cross-section.

1. An installation assembly (10),
for an electric machine, the installation assembly comprising:
a rotor shaft (16) extending along a longitudinal axis L,
a rotor (12) anchored in a rotationally fixed manner on the rotor shaft (16), and
a rotor device (20) which rotates together with the rotor (12)
wherein
the rotor device is equipped with means (24a; 24b; 24c) for fixing the rotor device to the rotor (12),
wherein the means (24a; 24b; 24c) are respectively formed in a part comprising the rotor device (20),
protrude from the rotor device (20) generally axially parallel to the longitudinal axis L of the rotor shaft (12) in a direction of the rotor (12), and
can be introduced into paired recesses (28a; 28b; 28c) of the rotor (12).

2. The installation assembly according to claim 1,
wherein
the means for fixing the rotor device (20) comprise first means (24a) and second means (24b) aligned obliquely or transversely in relation to said first means (24a) for centering the rotor device (20) on the rotor (12), as well as for fixing the rotor device (20) in a circumferential direction of the rotor (12), and
third means (24c) are provided for fixing the rotor device (20) in an axial direction in relation to the longitudinal axis L of the rotor shaft (16) of the rotor (12).

3. The installation assembly according to claim 1,
wherein
the means (24a; 24b; 24c) are respectively configured to be spatially separated from one another on the rotor device (20).

4. The installation assembly according to claim 2,
wherein
the means (24a; 24b; 24c) are respectively implemented as a plurality provided on the rotor device (20).

5. The installation assembly according to claim 1,
wherein
the means (24a; 24b; 24c) are respectively configured in the form of flat tongues with rectangular tongue cross-sections and, at least in an unloaded state, protrude generally perpendicularly from a contact surface of the rotor device (20), with which surface the rotor device (20) can be mounted flush on a front face of the rotor (12).

6. The installation assembly according to claim 2,
wherein
the second means (24b), when viewed in a direction of the longitudinal axis L of the rotor shaft (16),
are longer than the third means (24c) and
are shorter than the first means (24a).

7. The installation assembly according to claim 3,
wherein
the second means (24b) engage in an interlocking manner with the paired recesses (28b) of the rotor (12).

8. The installation assembly according to claim 7,
wherein
the second means (24b) are configured to be elastic in shape in a circumferential direction of the rotor (12), and
the second means (24b) adjoin a lateral wall of the paired recesses (28b) of the rotor (12) under a bias.

9. The installation assembly according to claim 3,
wherein
the first means (28a) and the third means (28c) engage with the respectively paired recesses (28a; 28c) of the rotor (12) with a lateral clearance.

10. The installation assembly according to claim 3,
wherein
the third means (28c) are provided in order to rearwardly engage with a respective shoulder (34) formed at an end of a paired third recess (28c) of the rotor (12).

11. The installation assembly according to claim 3,
wherein
the third means (24c) continue in a respective spring arm portion (32) extending obliquely to a front face of the rotor (12), wherein
the spring arm portion (32) forms an angle of less than 90° with the respectively paired third means (24c).

12. The installation assembly according to claim 1,
wherein
the rotor device is a pulse transmitter gear (20) of a device for electronic detection of a rotational movement and/or a rotational position of the installation assembly (10),
wherein the pulse transmitter gear (20) comprises electrically conductive regions and electrically non-conductive regions arranged in mutual rotation sequentially in a rotational direction of the pulse transmitter gear (20).

13. A method for producing an installation assembly for an electric machine (motor or generator) according to the features of claim 2, wherein
the rotor device (20) is mounted on the rotor shaft (16) in the direction of the rotor (12) until the first means (24a) engage with paired first recesses (28a) of the rotor (12),
the rotor device (20) is subsequently moved further in a direction of a front face of the rotor (12) until the second means (24b) engage with paired second recesses (28b) on the rotor (12) in order to center the rotor device (20) on the rotor (12) together with the first means (24a) and secure the rotor device (20) in a rotationally fixed manner on the rotor (12),
the rotor device (20) is then mounted flush on the front face of the rotor (12), and third means (24c) engage with their recesses (28c) on the rotor (12),
spring portions (32) of the third means (24c) are subsequently mounted flush on the front face of the rotor (12) and,
finally, the third means (24c) are plastically deformed until they rearwardly engage with shoulders (34) formed on the rotor (12) and secure the rotor device (20) in an axially fixed manner on the rotor (12).

14. The installation assembly according to claim 1, wherein the electric machine is an electrically commutated motor for driving a hydraulic pressure generator of an electronically slip-controllable, external force braking system of a motor vehicle.

15. The installation assembly according to claim 8, wherein the second means (24b) are elastic in shape via at least one longitudinal slit (30) in an extension direction of the second means (24b).
